(19) United States
(12) Patent Application Publication
(10) Pub. No.: US 2010/0157350 A1
(43) Pub. Date: Jun. 24, 2010

(54) IMAGE PROCESSING APPARATUS AND IMAGE PROCESSING METHOD

(75) Inventors: Kunio Yoshihara, Hachioji-shi (JP); Hiroyuki Kimura, Kawasaki-shi (JP); Mineko Sato, Yokohama-shi (JP); Shinichi Fukada, Kawasaki-shi (JP); Tsutomu Murayama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/641,210

(22) Filed: Dec. 17, 2009

(30) Foreign Application Priority Data
Dec. 19, 2008 (JP) 2008-323645

(51) Int. Cl. G06K 9/46; G06K 15/00; H04N 1/40

(52) U.S. Cl. 358/1.14; 358/3.28; 382/165

(57) ABSTRACT

To detect with high accuracy a particular pattern hardly disturbing eyesight by identifying a pixel where paper fiber cannot be identified, as a particular pattern pixel on the basis of an result of an of paper fiber from a particular color pixels. An image processing apparatus according to an embodiment of the present invention includes a paper fiber identification unit configured to identify paper fiber from an original read signal, a particular color pixel identification unit configured to identify a particular color pixel from the original read signal, a particular pattern detection unit configured to identify a pixel where paper fiber cannot be identified, as a particular pattern pixel on the basis of an identification result of the paper fiber identification unit from the particular color pixel, and a control unit configured to control the image processing apparatus in accordance with a result of the particular pattern detection unit.

### BACKGROUND OF THE INVENTION

1. Field of the Invention

The present invention relates to an image processing apparatus having a function of identifying paper fiber and an image processing method.

2. Description of the Related Art

For preventing leakage of personal information and corporate secrets, various methods of restricting a copy of a printed out document are proposed. For example, various methods are advised of specifying a document by using a barcode, a QR code, or the like as a marking for restricting a copy and managing a security process with respect to the document.

Among those, while a focus is narrowed down on a method of adding a particular marking on a document in which the making is also difficult to view with eyes, for example, Japanese Patent Laid-Open No. 2001-324898 discloses a technology of printing a “copy-forgery-inhibited pattern” at the time of output and floating the character pattern when the document is copied. In addition, Japanese Patent Laid-Open No. 5-91316 discloses a method of forming a machine number of an apparatus performing a copy on the copy document with a micro character or code by using an undistinguished color material and reading out the character or code at the time of reading out this copy document to specify the copier which has performed the copy. Moreover, Japanese Patent Laid-Open No. 6-135189 discloses a method of adding ultraviolet excitation fluorescent pigment to a recording material for the marking.

However, according to Japanese Patent Laid-Open No. 2001-324898, the “copy-forgery-inhibited pattern” can be viewed with the eyes, and it is possible to identify that the output printed material has some information added on. Also, when a copy of this printed material is made, the “character” floats up, but the copy itself can be performed, and only a restrictive effect is exerted.

According to Japanese Patent Laid-Open No. 5-91316, by viewing with a special apparatus, the apparatus printing the micro character or code can be specified, but the restriction of the copy is not carried out.

According to Japanese Patent Laid-Open No. 6-135189, the ultraviolet excitation fluorescent pigment which is a special material needs to be used for the recording material at the time of the recording, and it is necessary to use a reading apparatus capable of emitting ultraviolet at the time of reading out and reading the reflected fluorescence.

### SUMMARY OF THE INVENTION

The present invention provides an image processing apparatus configured to detect a particular pattern which hardly disturbs eyesight with a high accuracy by identifying a pixel where paper fiber cannot be identified, as a particular pattern pixel on the basis of a result of an identification of paper fiber from a particular color pixel and also provides an image processing method.

According to an embodiment of the present invention, there is provided an image processing apparatus including: a paper fiber identification unit configured to identify paper fiber from an original read signal; a particular color pixel identification unit configured to identify a particular color pixel from the original read signal; a particular pattern detection unit configured to identify a pixel where paper fiber cannot be identified, as a particular pattern pixel on the basis of an identification result of the paper fiber identification unit from the particular color pixel; and a control unit configured to control the image processing apparatus in accordance with a result of the particular pattern detection unit.

Further features of the present invention will become apparent from the following description of exemplary embodiments with reference to the attached drawings.

### BRIEF DESCRIPTION OF THE DRAWINGS

FIG. 1 shows a processing flow by a particular pattern detection unit.

FIG. 2 is a schematic configuration block diagram.

FIG. 3 is an explanatory schematic diagram for describing a difference in adhesion of a recording material on paper between colorless toner printing and colored toner printing.

FIG. 4 is an explanatory diagram for describing read of a colorless toner image.

FIG. 5 is an explanatory diagram for describing read of a colored toner image.

FIG. 6 is an explanatory diagram for describing a read situation of paper fiber in the case of the colorless toner printing.

FIG. 7 is an explanatory diagram for describing a read situation of paper fiber in the case of the colored toner printing.

FIG. 8 shows a weighting factor example used for obtaining a mean value.

FIG. 9 shows a paper fiber identification result example of a colorless toner printing original.

FIG. 10 shows a paper fiber identification result example of a colored toner printing original.

FIG. 11 shows a paper fiber identification result correction example.

FIG. 12 shows a particular color pixel identification result example of the colorless toner printing original.

FIG. 13 shows a particular color pixel identification result example of the colored toner printing original.

FIG. 14 shows a particular color pixel identification result correction example.

FIG. 15 is an explanatory diagram for describing a particular pattern pixel identification while referring to adjacent pixels.

FIG. 16 shows a flow for an image output control according to an embodiment of the present invention.

FIG. 17 shows a flow of the particular pattern detection unit according to another embodiment of the present invention.

FIG. 18 shows a particular pattern detection unit by a hardware circuit according to an embodiment of the present invention.

FIG. 19 shows a flow for a particular pattern printing processing according to an embodiment of the present invention.

FIGS. 20A to 20F show particular pattern printing examples.

### DESCRIPTION OF THE EMBODIMENTS

Hereinafter, embodiment of the present invention will be described by using the drawings.

A first embodiment of the present invention has the following configuration. It is noted that according to the present embodiment, a digital color copier will be described as an example for an image processing apparatus of the present invention. The same applies to other embodiments of the present invention.

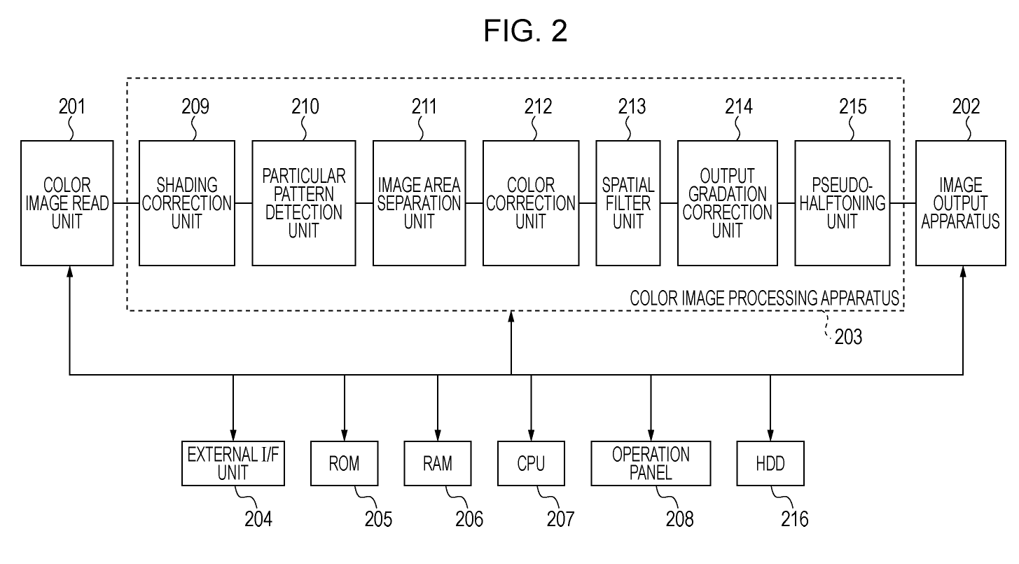

FIG. 2 is a block diagram of a schematic configuration of a digital color copier to which a color image processing apparatus according to an embodiment of the present invention is applied.

As shown in FIG. 2, the digital color copier according to the present embodiment is provided with a color image processing apparatus 203 which is composed of a shading correction unit 209, a particular pattern detection unit 210, an image area separation unit 211, a color correction unit 212, a spatial filter unit 213, an output gradation correction unit 214, and a pseudo-halftoning unit 215. Then, to the color image processing apparatus 203, a color image read unit 201, an image output apparatus 202, an external I/F unit 204, a ROM (Read Only Memory) 205, a RAM (Random Access Memory) 206, a CPU (Central Processing Unit) 207, an operation panel 208, and an HDD (Hard Disc Drive) 216 are connected, which constitute the digital color copier as a whole.

The color image read unit 201 is composed, for example, of a scanner unit (not shown) provided with a CCD (Charge Coupled Device) and is configured to read a reflected light image from an original with an R/G/B (R: read, G: green, and B: blue) CCD to be input to the color image processing apparatus 203.

An analog signal read by the color image read unit 201 is converted into a digital signal (not shown). The digital signal is sent to the shading correction unit 209, the particular pattern detection unit 210, the image area separation unit 211, the color correction unit 212, the spatial filter unit 213, the output gradation correction unit 214, and the pseudo-halftoning unit 215 in the stated order and output to the image output apparatus 202 as a digital color signal of C/M/Y/K (C:cyan, M:magenta, Y:yellow, and K:black).

The shading correction unit 209 is configured to apply a processing for removing various distortions generated in an illumination system, an imaging system, and an image pickup system of the color image read unit 201. Also, the shading correction unit 209 performs a color balance adjustment.

The particular pattern detection unit 210 is configured to convert the R/G/B signal (R/G/B reflectance ratio signal) whose color balance is adjusted into a signal easily dealt with an image processing system adopted in the color image processing apparatus 203 such as a luminance signal and also detect a hardly visible particular pattern (so-called “secret image”). In a case where the particular pattern is detected, an image output restriction signal for restricting an output of the read image is output to the CPU 207. It is noted that a detail of the particular pattern detection unit 210 will be described. In a case where the particular pattern is not detected, the R/G/B signal input from the shading correction unit 209 is converted into the luminance signal or the like and output to the image area separation unit 211.

The image area separation unit 211 is configured to separate the respective pixels in the input image into one of a character area, a dot area, and a photograph area from the R/G/B signal. On the basis of the separation result, the image area separation unit 211 outputs an area identification signal indicating to which area the pixel belongs to the color correction unit 212, the spatial filter unit 213, and the pseudo-halftoning unit 215 and also outputs the input signal which is output from the particular pattern detection unit 210 to the color correction unit 212 in a later stage as it is.

The color correction unit 212 is configured to perform a processing of removing color turbidity based on a spectral reflectance of the C/M/Y color material including an unnecessary absorbing component for faithful realization of the color reproduction.

The spatial filter unit 213 is configured to perform a spatial filter processing by using a digital filter on image data of the C/M/Y/K signal input from the color correction unit 212 on the basis of the area identification signal and correcting a spatial frequency characteristic to prevent blurring and graininess degradation of the output image. The pseudo-halftoning unit 215 is configured to perform a predetermined processing on the image data of the C/M/Y/K signal on the basis of the area identification signal similarly as in the spatial filter unit 213.

For example, the image signal in the area separated into the character by the image area separation unit 211 is subjected to a sharpness emphasis processing in the spatial filter processing by the spatial filter unit 213 for increasing reproducibility of a black character or a colored character in particular to emphasize a high frequency. At the same time, in the pseudo-halftoning unit 215, a binary or multi-valued processing in a high resolution screen suitable to the reproduction of the high frequency is selected.

Also, the image signal in the area separated by the image area separation unit 211 into the dot area is subjected to a low-pass filter processing for removing an input dot component in the spatial filter unit 213.

In the output gradation correction unit 214, after an output gradation correction processing of converting a signal such as a density signal into a dot area ratio which is a characteristic value of the image output apparatus 202 is performed, the pseudo-halftoning unit 215 performs pseudo-halftoning for a processing of separating the image into pixels eventually so that the respective gradations can be reproduced. Regarding the area separated by the image area separation unit 211 into the photography, a binary or multi-valued processing in a screen where significance is put on gradation reproducibility is performed.

The external I/F unit 204 is an interface connecting the color copier according to the present embodiment to an external information processing apparatus (not shown). In a case where the image read by the color copier according to the present embodiment is output to the external information processing apparatus and a case where the image and the image data in the external information processing apparatus is printed by the color copier according to the present embodiment, the image and the image data are sent and received via the external I/F unit 204.

The ROM 205 is a storage unit configured to store a program of the color copier according to the present embodiment. As this program is read out by the CPU 207, a function of the color copier according to the present embodiment is executed.

The RAM 206 is a storage unit configured to temporarily store data processed by the CPU 207.

The CPU 207 is configured to read out and execute the program stored in the ROM 205 to control various image processings and also the entirety of the color copier according to the present embodiment.

The operation panel 208 is composed, for example, of a display unit (not shown) such as a liquid crystal display, a setting button, a touch panel sensor, or the like. On the basis of the information input from the operation panel 208, operations of the color image read unit 201, the color image processing apparatus 203, and the image output apparatus 202 are controlled.

The HDD 216 is a high-capacity storage unit and is used for storing the image data.

The image data on which the above-described respective processings are applied is stored in the RAM 206 or the HDD 216 once. Then, the image data is read out at a predetermined timing to be input to the image output apparatus 202. The image output apparatus 202 is configured to output the image data on a recording medium (for example, paper, or the like). For example, a color image output apparatus or the like using an electrophotography system or an inkjet system can be exemplified, but the image output apparatus is not particularly limited. In addition, the schematic configuration block diagram shown in FIG. 2 is an example of the color system, but the embodiment of the present invention is also applicable to a black-and-white system. In that case, the color image read unit 201 becomes a black-and-white image read unit, and the color correction unit becomes unnecessary.

Also, as will be described below, according to the color copier according to the present embodiment, it is possible to print the particular pattern, and in a case where a “secret image formation mode” is instructed from the operation panel 208, it is possible to form the particular pattern using clear toner. It is noted that a configuration of the image output apparatus 202 capable of performing the image formation using the clear toner is described in U.S. 2009/0097046, and a description thereof will be omitted.

Furthermore, the “secret image formation mode” may be instructed from the external information processing apparatus (not shown) connected via the external I/F unit 204 instead of the operation panel 208. In this case, the image data to be printed and particular pattern data which will be described below are input from the external information processing apparatus (not shown) to the external I/F unit 204 as a print job. In the external I/F unit 204, this print job is transferred to the RAM 206 while following the program of the CPU 207. Furthermore, the print job is subjected to rendering by the RAM 206 and expanded to a bitmap image. The image data expanded to the bitmap image is sent to the image output apparatus 202 and visualized as an image.

On the other hand, the image signal subjected to the image processing by the color image read unit 201 and the color image processing apparatus 203 and once stored in the RAM 206 or the HDD 216 can be displayed on the operation panel 208 as a preview and output via the external I/F unit 204 to the external information processing apparatus (not shown).

### Principle of the Particular Pattern Detection

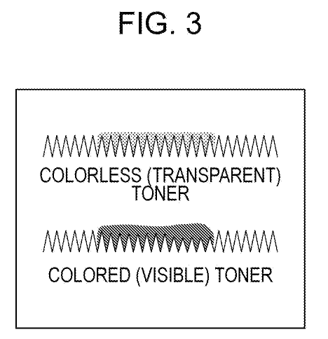

Before the embodiment of the above-described particular pattern detection unit 210 is described in detail, a principle for detecting the particular pattern according to the present embodiment will be described by using FIG. 3. FIG. 3 schematically shows a state of printing by using colorless (transparent) toner on a white normal paper surface through the electrophotography system and a state of printing by using colored (visible) toner for comparison. It is noted that according to the following embodiment group, a description will be provided while the colorless color is not limited to completely colorless and includes colors which can be regarded as substantially colorless. When the colorless (transparent) toner is read by the normal color image read unit 201, as a toner part is colorless and transparent, almost no difference exists between the paper functioning as the recording medium and the image signal luminance (the luminance difference is within two degrees), it is almost impossible to read this as normal image information. According to the following embodiment group, the colorless (transparent) toner and the paper have (substantially) the same color. However, in the electrophotography system, as solid toner is thermally fused and pressurized to fix an image on the paper, the toner hardens as a solid matter on fiber of the paper. Therefore, when the image pixel is read and a scattered reflection image caused by the paper fiber is read from the signal, it is possible to identify a toner printing pixel and the paper functioning as the recording medium. Furthermore, in a strict sense, as the colorless (transparent) toner slightly passes the scattered reflection image, the paper fiber looks thin but amplitude of a paper fiber signal is narrow. If a threshold is provided to a signal level, similarly as in the colored (visible) toner, it is possible to identify this as a pixel where the paper fiber cannot be detected.

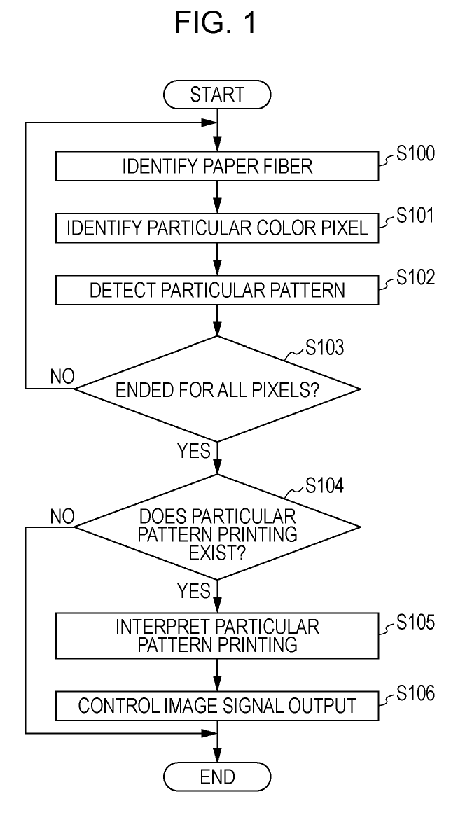

It is noted that in the case of a paper type in which the paper fiber cannot be detected at a high accuracy such as coated paper, the accuracy is decreased according to the present embodiment. Next, an embodiment of the particular pattern detection unit 210 will be described where the processing flow of the particular pattern detection unit 210 will be described in detail by using FIG. 1. According to the present embodiment, as the particular pattern detection unit 210 executes the program stored in the ROM 205 with the CPU 207, the particular pattern detection processing and an image output limitation are executed. First, in FIG. 1, S100 is a processing of identifying the presence or absence of the paper fiber, which is performed on the basis of the image signal subjected to the shade correction and the color separation into R/G/B.

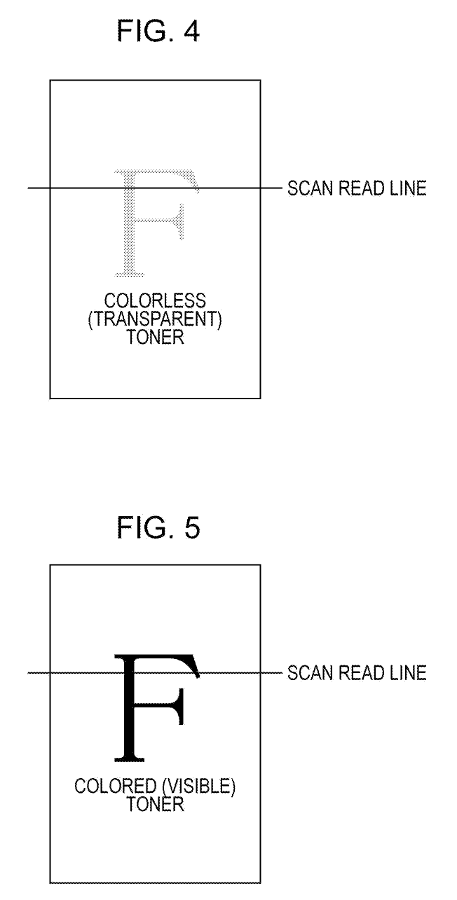

An embodiment of the paper fiber identification S100 will now be described. FIGS. 4 and 5 respectively show a case where a character “F” is printed by using the colorless (transparent) toner and a state where the original printed by using the colored (visible) toner is read for one line by the color image read unit 201. While respectively corresponding to FIGS. 4 and 5, FIGS. 6 and 7 are explanatory diagrams for describing a luminance signal A(i) and a processing of identifying the presence or absence of the paper fiber from the luminance signal A(i).

In a case where the original is read through the color separation into the three colors of R/G/B, in general, the luminance signal A(i) is represented as follows.

A(i)=(a*R(i)+b*G(i)+c*B(i))/(a+b+c)

Herein (a+b+c=1), and a, b, and c are constants.

According to the present embodiment, to simplify an operation, A(i)=(R(i)+2*G(i)+B(i))/4 is established.

A signal mean value M(i) is a weighted mean value by using the luminance signal A(i) of a pixel in the vicinity of a target pixel position as represented in Expression (1).

M(i)=ΣΣR×A(i) Expression (1)

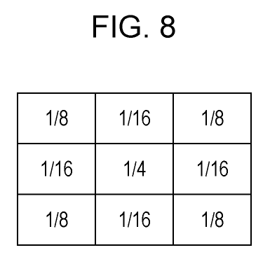

Herein R denotes a weighting factor on the pixel at the adjacent position, and a value shown in FIG. 8 is used, for example. According to the present embodiment, the value is a mean value of eight pixels in the surrounding area of the target pixel.

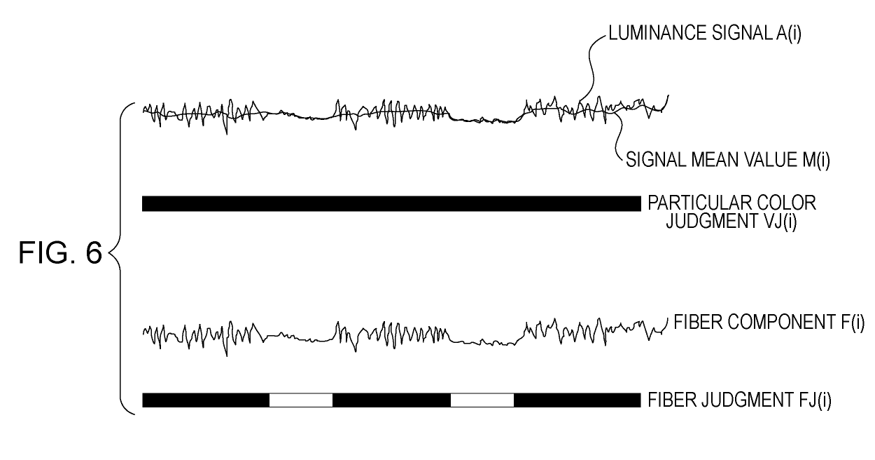

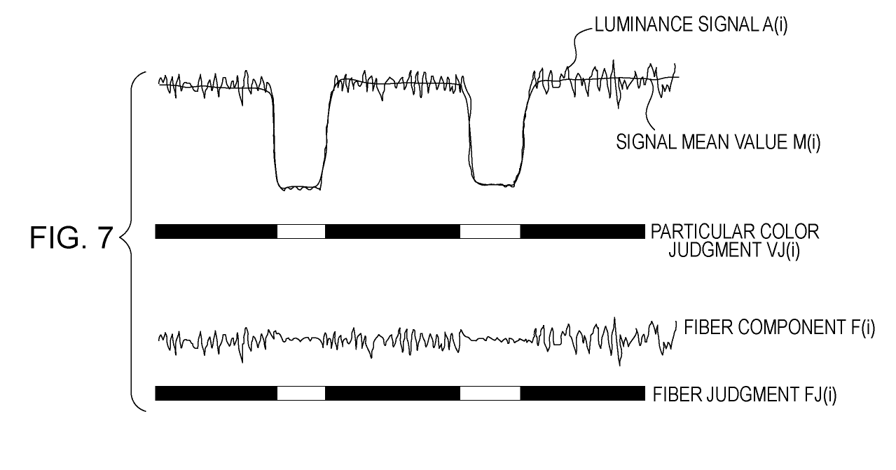

As the paper fiber component is normally overlapped on this mean value, as shown in FIGS. 6 and 7, by using the mean value M(i) from the above-described luminance signal A(i), a fiber component F(i) can be extracted, for example, while following Expression (2).

F(i)=[255/A(i)]×[A(i)−M(i)] Expression (2)

It is noted that the luminance signal A(i) is represented by 8 bits and takes a value from 0 to 255, which is for the most luminous part.

A result of judging the presence or absence of the fiber component from the fiber component F(i) is denoted by FJ(i).

The judgment follow Expression (3) described below. When K1<an absolute value F(i)<K2, FJ(i)=0: judged that the fiber exists.

In other cases, FJ(i)=1: judged that the fiber does not exist. Expression (3)

This means that the paper fiber is read as a signal value of an amplitude in a range where no influence is caused on the image. In order to identify the image signal of this amplitude and an image signal read through the electrophotography in a case where the toner is attached to such a degree that the fiber structure is completely covered, a constant K1 is set.

Also, a constant K2 is set in order to avoid a misjudgment as an acute change point of the image and also avoid an influence of noise which the luminance signal A(i) itself has. In FIGS. 6 and 7 too, it is understood that the paper fiber cannot be detected at the character “F” part. It is noted that this judgment is sequentially performed over the entire original for each of the pixels.

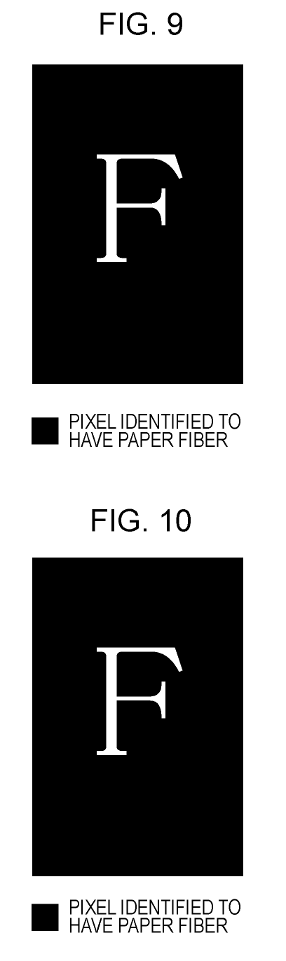

FIGS. 9 and 10 respectively correspond to FIGS. 4 and 5, and the original printed by using the colorless (transparent) toner and the original printed by using the colored (visible) toner are read to show a result of identifying the presence or absence of the paper fiber.

For the colorless (transparent) toner and the colored (visible) toner as well, at the character “F” part, a gap of the paper fiber is filled with the toner, and the paper fiber component cannot be read. Therefore, as a result of the above-described judgment, it is judged that the fiber component does not exist at the “F” part. Another embodiment of the paper fiber identification S100

The previous embodiment illustrates the example in which the presence or absence of the paper fiber is detected from the luminance signal A(i). As another embodiment, a method is described below by using Expression (4) in which the luminance signal A(i) is converted into a density signal D(i), and then the identification processing is carried out.

D(i)=255−K3×log A(i)+K4 Expression (4)

Where, K3 and K4 are constants, and the density signal D(i) is a value from 0 to the maximum value 255, which is for the most luminance part. If a bypass filter H for extracting only a so-called two-dimensionally high spatial frequency component is used for the density signal D(i), it is possible to directly extract only the fiber component F(i) described above in detail.

F(i)=ΣΣD(i)×H Expression (5)

That is, this method takes into account a state in which the spatial frequency of the image or the frequency component derived from the pseudo-halftoning is sufficiently lower than the fiber component F(i). Hereinafter, as the method of judging the presence or absence of the fiber component from the obtained fiber component F(i) is the same as Expression (3) described above, and a subsequent description will be omitted. Another embodiment of the paper fiber identification S100

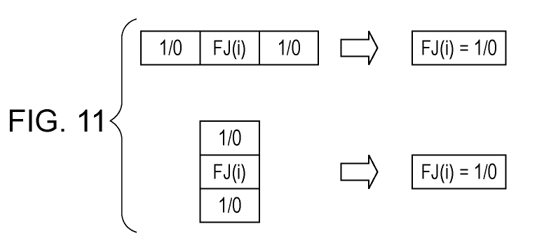

According to both the above-described embodiments, the judgment result on the presence or absence of the paper fiber FJ(i) is generated for each of the pixels, but the judgment result on the paper fiber is not continuously switched in adjacent minute areas equivalent to 600 DPI. Therefore, in consideration of such a characteristic, another embodiment for judging and correcting the judgment result on the presence or absence of the paper fiber FJ(i) will be illustrated. That is, in a case where the judgment result at the pixel position where the patterns shown, for example, in FIG. 11 are adjacent one another is generated, the judgment result on the presence or absence of the paper fiber FJ (i) at the target pixel position is corrected as shown in the drawing.

Through this correction, it is possible to correct judgment result generated in isolation in units of pixel by the noise or the like, and a stable final judgment result on the paper fiber can be obtained. It is noted that it is also possible to execute the correction while referring to the judgment result on the adjacent pixels in an area still larger than the area shown in FIG. 11.

In FIG. 1, S101 is a particular color pixel identification processing of judging whether or not this is a pixel where the printing is visually made by using the colored recording material in contrast with the paper color for each of the pixels.

An embodiment of the particular color pixel identification S101 will now be described. In order to judge the existence of the particular color pixel for each of the pixels, it is possible to simply obtain from the luminance signal A(i) through Expression (6).

In case of A(i)<K5, P(i)=0, judged as the visible printing pixel.

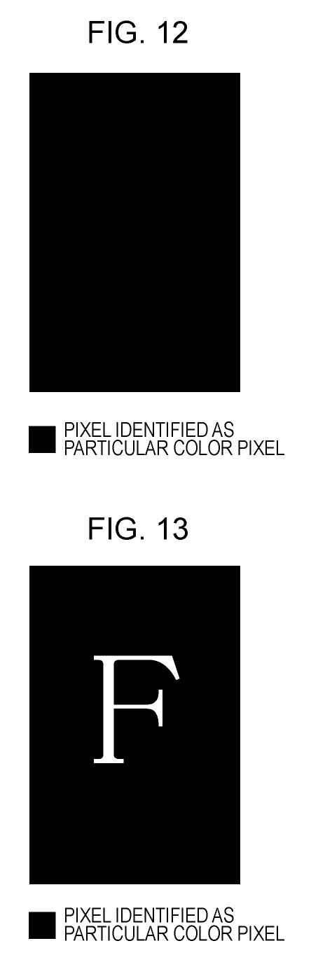

In other cases, P(i)=1, not judged as the visible printing pixel. Expression (6)

Where P(i) denotes a judgment result indicating that the visible printing by using any recording material is made in the pixel. In a case where the luminance signal A(i) is equal to or smaller than a constant K5, it is judged as the visible printing pixel. That is, in a case where the luminance of the recording material is low to a certain degree, the reflected light caused by the paper fiber is absorbed by the recording material, and the fiber component cannot be detected at a high accuracy. Therefore, this is excluded from the judgment target pixel. FIGS. 12 and 13 respectively show results of the judgment through Expression (6) by reading the original printed by using the colorless (transparent) toner and the original printed by using the colored (visible) toner. In the original printed by using the colorless (transparent) toner, the colorless (transparent) toner transmits the reflected light caused by the paper fiber to some extent, and it is judged that the luminance signal A(i) is larger than the constant K5 and the pixel is not the visible printing pixel. On the other hand, in the original printed by using the colored (visible) toner, the reflected light caused by the paper fiber is absorbed into the colored (visible) toner, and it is judged that the luminance signal A(i) is smaller than the constant K5 and this is the visible printing pixel. Therefore, it is judged that the character “F” part is the visible printing pixel.

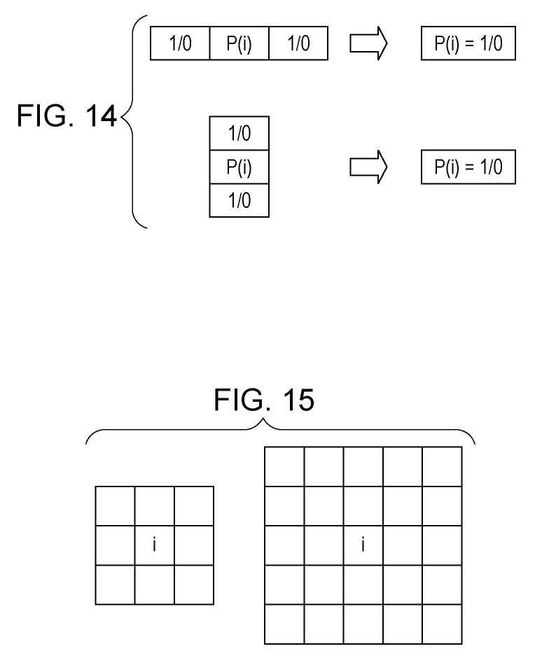

Another embodiment of the particular color pixel identification S101 will now be described. According to the above-described embodiment, the judgment P(i) on the presence or absence of the visible printing pixel for each of the pixels is generated, but fundamentally, the visible printing pixel judgment results are not continuously switched for each minute pixel equivalent to 600 DPI. Therefore, another embodiment for judging and correcting the visible printing pixel judgment P(i) is illustrated. That is, for example, in a case where a judgment result on the pixel position where a pattern shown in FIG. 14 is adjacent is generated, the judgment P(i) result on the printing pixel at the target pixel position is corrected as shown in the drawing.

Through this correction, it is possible to correct the judgment result generated in isolation in units of pixel due to the noise or the like, and the stable final visible printing pixel identification result can be obtained. It is noted that the correction using the judgment result on the adjacent pixels by referring further more widely than that shown in FIG. 14 can be carried out.

In FIG. 1, particular pattern detection S102 is a processing of using the identification result on the presence or absence of the paper fiber FJ(i) and the visible printing pixel identification result P(i) obtained through the judgment for each of the pixel to identify whether or not the respective pixels are a part of the original on which the particular pattern is printed.

An embodiment of the particular pattern detection S102 will now be described. Whether or not the particular pattern is printed and created on the original is judged on the basis of the above-described identification result on the presence or absence of the paper fiber FJ(i) and the visible printing pixel identification result P(i) while the following Expression (7) as will be described below.

In a case where P(i)=1 and FJ(i)=1, IJ(i)=1, judged as the particular pattern pixel.

In other cases, IJ(i)=0, judged as pixel except for the particular pattern pixel. Expression (7)

It is noted that this is temporarily stored in the RAM 206 as this particular pattern pixel identification result IJ(i).

Additionally, another embodiment of the particular pattern detection S102 is described. According to the above-described embodiment, the judgment example for each of the pixels is represented by paying attention to only one pixel in Expression (7). Another embodiment is represented in which the judgment is made by referring to a surrounding in a two-dimensional manner to some extent by using Expression (8).

In the case of ΣΣP(i)×FJ(i)>K7, IJ(i)=1, judged as the particular pattern pixel.

In other cases, IJ(i)=0, judged as pixel except for the particular pattern pixel. Expression (8)

For example, as shown in FIG. 15, when a total P(i)×FJ(i) at positions of eight pixels or 24 pixels adjacent with the target pixel position set as the center is obtained, and a threshold processing is performed at a constant K7, by taking into account the surrounding of the target pixel, it is possible to obtain the stable judgment result which is resistant to the noise for each of the pixels.

In FIG. 1, when the respective processings of the paper fiber presence or absence identification S100, the visible printing pixel identification S101, and the particular pattern detection S102 are ended for all the pixels in one page, in S104, it is judged whether or not the particular pattern exists in the relevant page.

In FIG. 1, in a case where the particular pattern does not exist, the present flow is ended in S104, and the respective image signals subjected to the color separations of R/G/B stored in the storage unit (not shown) for the read pages are output to the image area separation unit 211 as outputs of the particular pattern detection unit 210.

If, the particular pattern exists, the flow is branched from S104 to S105 to interpret the particular pattern.

Next, an embodiment of the particular pattern printing interpretation S105 will be described. As an information embedding pattern, a barcode, a QR code, and the like are widely proposed. These patterns are associated with the control after the reading as the particular pattern according to the present embodiment and previously printed on the original. Also, the control after the reading is previously stored in the reading apparatus. For example, the control includes copy restriction, read restriction, and the like.

The barcode and the QR code are widely disclosed, for example, in Japanese Patent Laid-Open No. 2001-318886, and a description thereof will be omitted here.

In addition, even when not only the above-described code but also the character itself is printed as the particular pattern, the character can be read of course according to the present embodiment. For example, while the characters “secret”, “confidential”, and the like are previously printed, and these characters may be interpreted through character recognition. The printing of the particular pattern will be described below.

Here, an embodiment of image signal output control S106 will be described. In FIG. 1, in a case where the copy restriction and the read restriction are interpreted in the particular pattern printing interpretation S105, if reading is currently performed, the reading is immediately cancelled. Also, in a case where another part of the original where the particular pattern is printed is already read and the image stored in the RAM 206 or the HDD 216 exists, deletion is performed. Also, a processing may be performed for displaying that the particular pattern is detected on the operation panel 208 or notifying an external management apparatus of that status.

### Detail Flow of the Image Signal Output Control S106

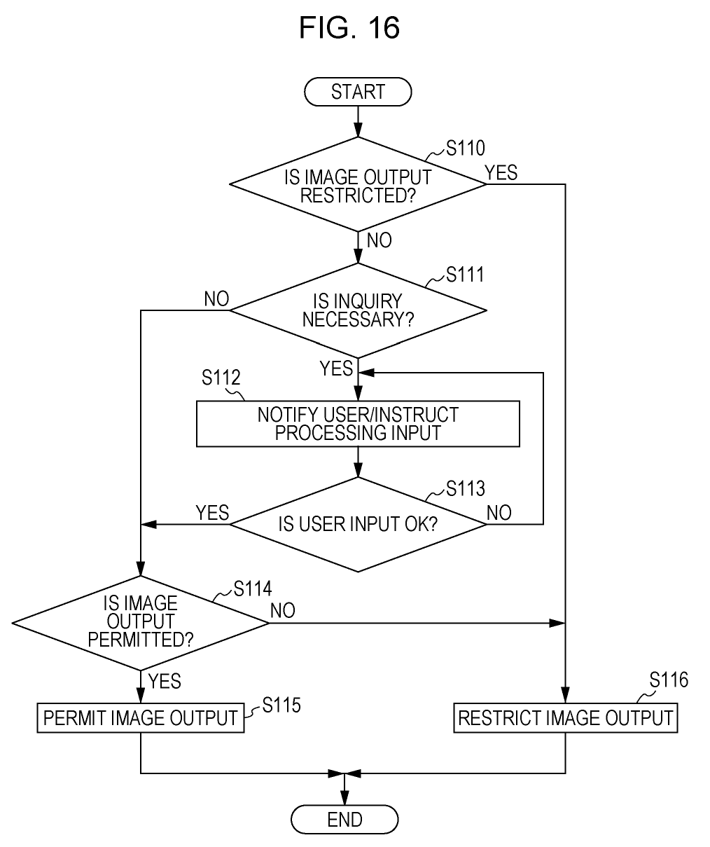

Detail flow of another embodiment of the image signal output control S106 will be described with reference to FIG. 16. As a result of the particular pattern printing interpretation S105, whether this is the image output including copy and read is judged in S110, and in a case where the output is restricted, the flow advances to S116 to immediately interrupt the reading if the original is currently read and eject the remaining originals from the reading apparatus. Also, if the reading is already ended, the image temporarily stored in the storage apparatus such as the RAM 206 or the HDD 216 is deleted. When necessary, a status that the reading is restricted is displayed on the operation panel 208 to notify the user. Then, the present flow is ended.

On the other hand, in a case where the output is not restricted in S110, the flow advances to S111 to judge whether or not an inquiry needs to be made to the user. In a case where whether the image output restricted is effected or the output is permitted cannot be simply judged such as a case where the particular pattern is not correctly read and cannot be interpreted or a case where a plurality of patters are detected and the contents have inconsistency, the flow advances to S112 to notify the user of the situation and instruct the user to input a corresponding action. Then, in S113, the processing stands by for the instruction input by the user, and in a case where there is no input, the flow returns to S112. In S113, in a case where the user input exists, the flow advances to S114 to determine whether or not the image output is permitted. In a case where the output is not permitted in S114, the flow advances to S116. The operation in S116 is already described above. In a case where the output is permitted in S114, the flow advances to S115. If the original is currently read, the reading continues. Also, if the reading is already ended and the image temporarily stored in the storage apparatus such as the RAM 206 or the HDD 216 exists, the flow advances to the next processing, and the present flow is ended.

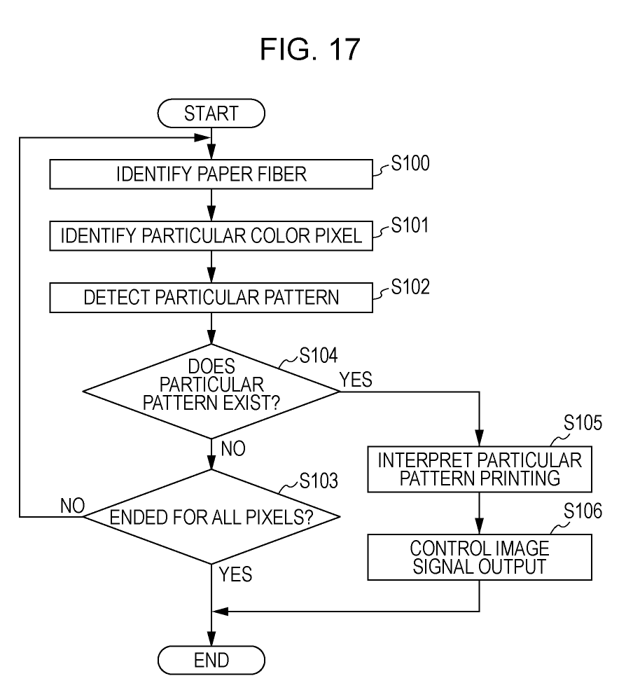

In addition, another embodiment of the particular pattern detection unit 210 will be described. FIG. 17 shows another embodiment of the particular pattern detection unit 210. It is noted that the part for performing the same processing as that in FIG. 1 described above is denoted by the same numeral, and the description thereof will be omitted.

In FIG. 1, according to the described embodiment of the particular pattern detection unit 210, the particular pattern pixel is detected on the entire page of the original, and thereafter, the judgment on the presence or absence of the particular pattern printing is performed.

In contrast to this, a difference between the present other embodiment and the previous embodiment resides in that the presence or absence of the particular pattern in S104 is determined immediately after the particular pattern pixel detection S102. According to this embodiment, without waiting for the processing on the entire page area, as soon as the particular pattern is detected, the flow can advance to the next processing, which can increase the process speed. Another embodiment of the particular pattern detection unit 210

Another embodiment of the particular pattern detection unit 210 shown in FIG. 17 is carried out by way of software in the CPU 207, but this embodiment can be realized through a so-called pipeline processing by way of hardware as image signals obtained by subjecting the original to raster scan are processed sequentially for each pixel.

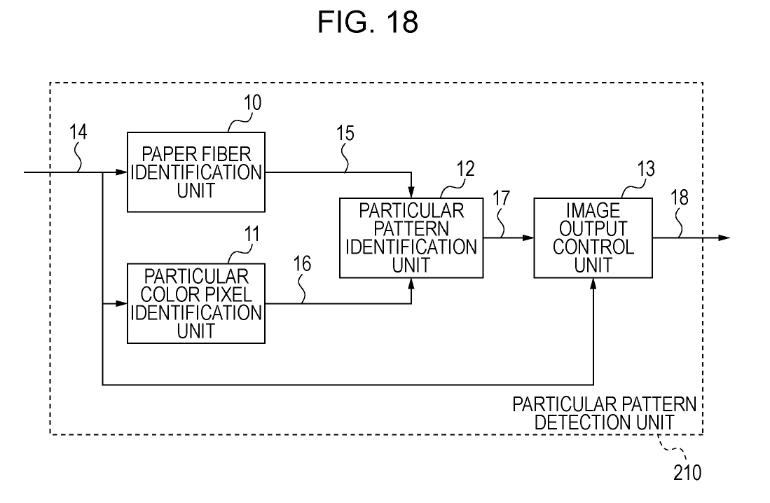

FIG. 18 shows an embodiment by way of the hardware as another embodiment of the particular pattern detection unit 210. In FIG. 18, an image signal 14 corrected by the shading correction unit 209 and subjected to color separation into R/G/B is input to a paper fiber identification unit 10. The paper fiber identification unit 10 generates a luminance signal from the image signal 14 subjected to the color separation into R/G/B, realizes the operation previously described as S100 by a logical circuit, and outputs a paper fiber identification result signal 15 indicating whether or not this is paper fiber to a particular pattern identification unit 12. Also, the image signal 14 subjected to the color separation into R/G/B is input to a particular color pixel identification unit 11. The particular color pixel identification unit 11 generates a luminance signal from the image signal 14 subjected to the color separation into R/G/B and realizes the operation described as S101 in the above by a logical circuit. Then, the particular color pixel identification unit 11 outputs a particular color pixel identification result signal 16 to the particular pattern identification unit 12. The particular pattern identification unit 12 realizes the operation previously described as S102 by the logical circuit and outputs a particular pattern identification result signal 17 to a selection signal terminal of an image output control unit 13. On the other hand, the image signal 14 subjected to the color separation into R/G/B is further input to the image output control unit 13. The image output control unit 13 determines whether or not the image signal 14 subjected to the color separation into R/G/B passes through the processing previously described as S106 to be output as an output image signal 18 of the particular pattern detection unit 210 to the image area separation unit 211 and the external I/F unit 204.

The operation circuits of these respective units can be realized as the pipeline processing in synchronism with an image clock (not shown). This embodiment is more suitable to a high speed processing as compared with the previous embodiment and can be therefore applied to a high speed machine.

### Application Expansion of Sheet and Toner

In the above description, it is set that the paper of the original is white, and the toner is colorless and transparent.

At this time, further, the following cases of printing the particular pattern by using toner with the same color as the color of paper which is difficult to identify with the visual recognition are considered. The pixels read as the result are white pixel.
(1) White paper with white toner
(2) Colored paper with toner having the same color as the colored paper

In FIG. 4 which is the explanatory diagram for describing the image reading, if the printing is performed with the toner having the same color as the paper color instead of the colorless (transparent) toner, as there are no difference in the paper, the luminance, and the saturation, the printing character “F” is hardly recognized with the eyes. Therefore, the same result as that in FIG. 4 is obtained.

In addition, in FIG. 6 which is the explanatory diagram for describing the reading status of the paper fiber, the printing with the toner having the same color as the paper color may be performed instead of the colorless (transparent) toner. In this case, an absolute value of a signal mean value M(j) varies depending on the luminance of the paper, but a waveform of the signal mean value M(j) and a luminance signal A(j) itself is identical to FIG. 6. Furthermore, a waveform of a fiber component F(j) is also almost identical to FIG. 6. The description is the same as above.

Therefore, the same algorithm can be applied for the detection method of the particular pattern detection unit 210 irrespective of the used toner color.

Next, another embodiment of the particular color pixel identification S101 will be described. The visible printing pixel identification S101 of FIG. 1 is a processing of judging whether or not this is a pixel where the printing is visibly made with the colored recording material contrast with the paper color for each of the pixels. In a case where the same color is set for the paper and the toner for printing the particular pattern, the judgment is made as follows.

In order to judge the existence of the visible printing pixel for each of the pixels, it is easy to obtain a result from the luminance signal A(i) through Expression (9).

In a case of A(i)=K8, P(i)=1, not judged as the visible printing pixel or the printing pixel.

In other cases, P(i)=0, judged as the visible printing pixel. Expression (9)

Here, K8 denotes a luminance value of the paper.

Herein, P(i) denotes a judgment result representing that the visible printing in the pixel is made with any recording material. In a case where the luminance signal A(i) is on a level with a constant K8, it is not judged as the visible printing pixel or the printing pixel. On the other hand, in a case where the luminance signal A(i) is not on a level with the constant K8, it is judged as the visible printing pixel where the visible printing is made with the toner having a luminance different from the paper.

Therefore, a result of identifying the original where the printing is made with the toner with the same color as the paper and a result of identifying the original where the printing is made with the toner with the color different from the paper are respectively similar to FIGS. 12 and 13.

Here, an embodiment of the particular pattern printing will be described. An operation flow will be described according to an embodiment of the apparatus for printing the particular pattern.

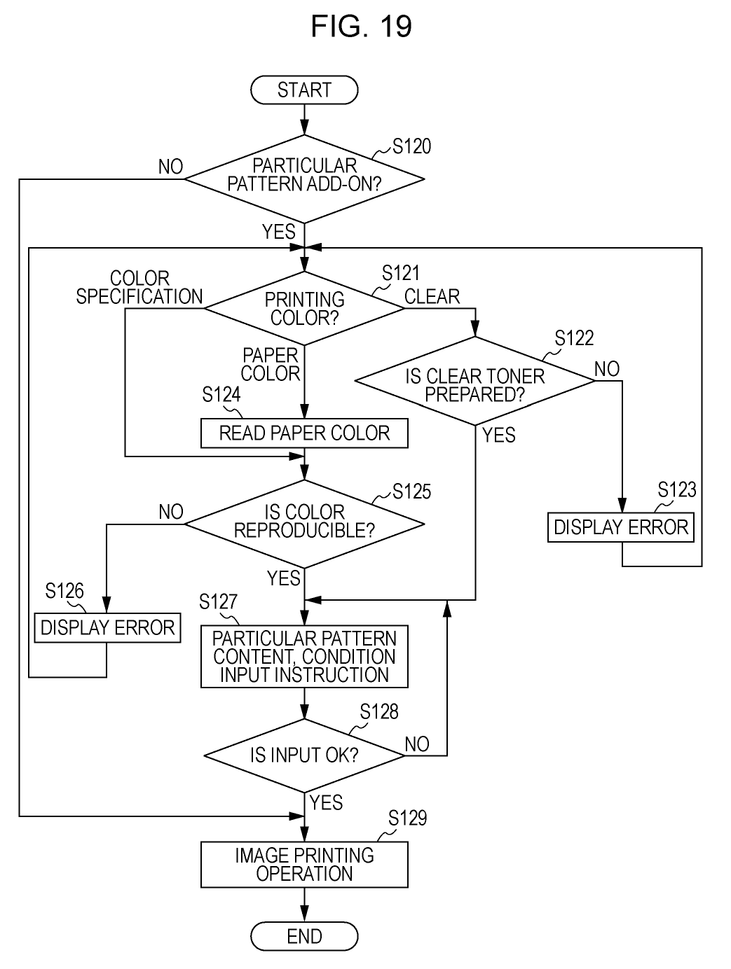

In FIG. 19, first, when the operation panel 208 is operated by the user and a setting for the image formation is input, in S120, the CPU 207 of the color image processing apparatus 203 determines whether or not the particular pattern is printed. In actuality, it is determined whether or not a key for selecting a mode “secret image formation mode” for printing the particular pattern is pressed in the operation panel 208. At this time, in a case where the particular pattern is not printed, that is, as this is the normal operation for the apparatus, the flow advances to S129. In S120, in a case where it is determined that the particular pattern is printed, as which color the particular color is set is displayed on the operation panel 208 in S121 to wait for the input from the user. In a case where the clear toner is specified, the flow shifts to S122 to determine whether or not the clear toner is prepared. In a case where the clear toner is not prepared, the user is notified of that the preparation is not ready as the toner is running out, for example, in S123. Then, the flow returns to S121 to display in which color the particular pattern is printed on the operation panel 208 again. On the other hand, in a case where the color of the particular pattern is specified as the same color of the paper in S121, the flow advances to S124, and the recording paper color is read. An instruction is displayed for the user to place the recording sheet in the color image read unit 201. When the recording sheet is placed on the color image read unit 201, the color of the sheet is read. It is noted that if the read value is stored together with the sheet name, the stored value can be read and used for the subsequent times.

Also, in S121, in a case where the paper color is previously read in the above-described manner or a case where the particular color is specified through the determination by the user (for example, “white”), the printing color is set, and the flow advances to S125. In S125, it is determined whether or not the read paper color or the specified color can be reproduced by the apparatus and whether the special color toner (for example, “white”) is necessary and prepared. At that time, in a case where it is determined that the particular pattern cannot be printed in the same color as the paper color as the toner is not ready, for example, in S126, the user is notified of that effect, and the flow returns to S121 to display in which color the particular pattern is printed on the operation panel 208 again.

In S125, in a case where it is determined that the particular pattern can be printed in the same color as the paper color, in S127, a display for instructing the user to input conditions such as a content of the particular pattern and a location is performed on the operation panel 208. In S128, it is determined whether or not the content input in S127 is appropriate. In the case of NG as a result of checking, the flow returns to S127 to instruct the user to input conditions again. In the case of OK in S127, the flow returns to S129, and an operation starts to print the image. The operation of printing the image is a normal operation for a color image copier including a multifunctional peripheral includes a copy operation and printing out of an electronic document. It is noted that the flow passes S127 and S128, and in a case where an image printing operation S129 is carried out, the particular pattern is of course printed at the same time as the normal image forming operation.

### Particular Pattern Printing Example

Next, the setting conditions for printing the particular pattern and printing examples will be described.

The setting conditions for printing the particular pattern in S127 described above include the followings.
1. Meaning of the particular pattern Security setting
   Copy restriction, read restriction, permit for particular users, and the like.

The followings are printing instructions for the particular pattern.
2. Location
   (A) Specify a location for the printing
   (B) Specify outline positions such as margins and corners
   (C) Specify areas through division
3. Number of repetition
   (D) Specify the number of the particular patterns
4. Overlap correction
   (E) In a case where the visible image exists, the particular pattern is automatically moved by the apparatus to a location where the overlap does not occur
5. Repetition
   (F) A plurality of the particular patterns are printed over the entire surface as a repetition pattern (specify the number of the repeated particular patterns)

In this case, the particular pattern can be overlapped with the visible image, and the noise and the crack are corrected by selecting the pattern which is correctly read and overlapping a plurality of patterns.

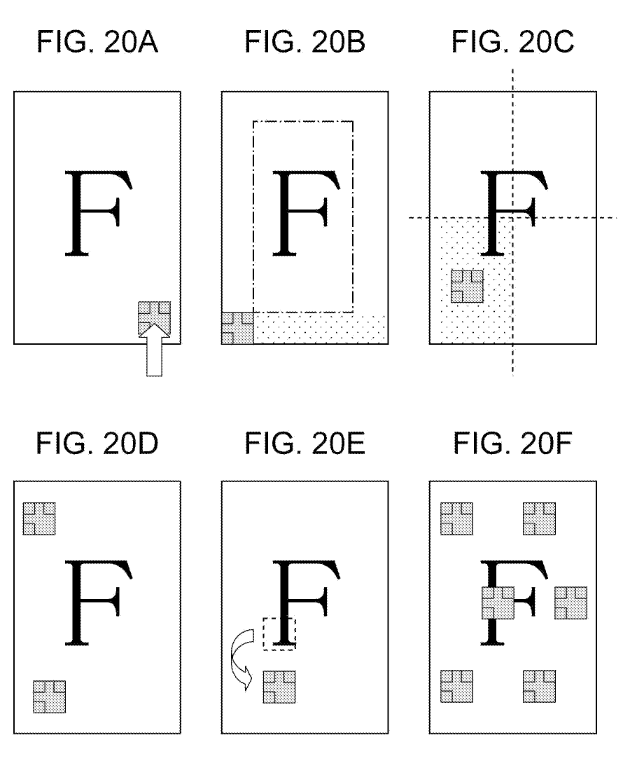

FIGS. 20A to 20F respectively show printing examples of the particular patterns corresponding to the above-described items (A) to (F).

A method of deciding a location for printing the particular pattern will be described below.

An instruction for inputting the printing location setting conditions for the particular pattern is displayed on the operation panel 208 or the display unit of the external information processing apparatus (not shown), and the user is instructed to perform an input operation for the setting conditions. On the basis of the input setting conditions, an optimal location candidate for the particular pattern printing is calculated by the CPU 207 and displayed on the operation panel 208 or the display unit of the external information processing apparatus (not shown). When the particular pattern printing candidate location is accepted by the user, the candidate location is decided. If the candidate location is not accepted by the user, the user is instructed to input a modifying location to modify the location. Of course, from the beginning, a mode may be provided for the user to manually specify the location.

As described above, according to the present embodiment, the information can be recorded with the printing which has almost no difference in the density and the color difference and which has the same color as the paper color and is hardly recognized with the eyes, and it is therefore increase the information confidentiality.

Furthermore, as the particular pattern is hardly recognized with the human eyes, even when the particular pattern is printed at an arbitrary location in an area where the visible image is not printed without changing the visible printing layout on the original, the printing hardly disturbs the eyesight, and it is possible add the information through add-on.

Also, without using toner which absorbs special light in the invisible area or a reading apparatus which uses the special light, the embodiment can be constructed by the reading apparatus based on the normal visible light.

According to the above-described embodiments, as the pixel where the paper fiber cannot be identified as the particular pattern pixel from the result of identifying the paper fiber from the particular color pixel, it is possible to detect the particular pattern pixel with high accuracy and use the particular pattern pixel for the control on the image processing.

Also, as the particular color pixel, by using the color which has almost no difference in the density and the color difference, the information can be recorded with the printing which has the same color as the paper color and is hardly recognized with the eyes, and it is therefore increase the information confidentiality.

Furthermore, as the particular pattern is hardly recognized with the human eyes, even when the particular pattern is printed at an arbitrary location in an area where the visible image is not printed without changing the visible printing layout on the original, it is possible to provide the particular pattern image which hardly disturbs the eyesight.

Also, without using the toner which absorbs the special light in the invisible area or the reading apparatus which uses the special light, the embodiment can be constructed by the reading apparatus based on the normal visible light.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-323645 filed Dec. 19, 2008, which is hereby incorporated by reference herein in its entirety.

What is claimed is:

1. An image processing apparatus comprising:
a paper fiber identification unit configured to identify paper fiber from an original read signal;
a particular color pixel identification unit configured to identify a particular color pixel from the original read signal;
a particular pattern detection unit configured to identify a pixel where paper fiber cannot be identified, as a particular pattern pixel on the basis of an identification result of the paper fiber identification unit from the particular color pixel; and
a control unit configured to control the image processing apparatus in accordance with a result of the particular pattern detection unit.

2. The image processing apparatus according to claim 1,
wherein the particular color pixel identification unit identifies white as the particular color.

3. The image processing apparatus according to claim 1,
wherein the particular color pixel identification unit identifies a color of an original paper as the particular color.

4. The image processing apparatus according to claim 1,
wherein a pattern detected by the particular pattern detection unit is printed with a transparent recording material and also composed of a white pixel.

5. The image processing apparatus according to claim 1,
wherein a pattern detected by the particular pattern detection unit is printed with a transparent recording material and also composed of a pixel having a same color as a color of an original paper.

6. The image processing apparatus according to claim 1,
wherein a pattern detected by the particular pattern detection unit is printed with a recording material having a same color as a color of an original paper and also composed of a pixel having the same color as the color of the original paper.

7. The image processing apparatus according to claim 1,
wherein the control on the image processing apparatus includes a processing of restricting copying.

8. The image processing apparatus according to claim 1,
wherein the control on the image processing apparatus includes a processing of restricting image reading.

9. The image processing apparatus according to claim 1,
wherein the control on the image processing apparatus includes a processing of at least one of displaying and notifying that the particular pattern is detected.

10. An image processing method comprising:
identifying paper fiber from an original read signal;
identifying a particular color pixel from the original read signal;
identifying a pixel where paper fiber cannot be identified, as a particular pattern pixel on the basis of an identification result in the paper fiber identification step from the particular color pixel; and
controlling the image processing apparatus in accordance with a result in the particular pattern detection step.
